(19) United States
(12) Patent Application Publication
(10) Pub. No.: US 2006/0230421 A1
(43) Pub. Date: Oct. 12, 2006

(54) Method of using an entertainment system and an apparatus and handset for use with the entertainment system

(75) Inventors: Miles Pierce, Austin, TX (US); Philip Ted Kortum, Austin, TX (US); Theodore Pasquale, Austin, TX (US)

Correspondence Address: TOLER SCHAFFER, LLP, 5000 PLAZA ON THE LAKES, SUITE 265, AUSTIN, TX, 78746, US

(73) Assignee: SBC Knowledge Ventures, LP, Reno, NV (US)

(21) Appl. No.: 11/093,736

(22) Filed: Mar. 30, 2005

(51) Int. Cl. H04N 7/173; H04N 7/16

(52) U.S. Cl. 725/106; 725/133; 725/141

(57) ABSTRACT

A method of using an entertainment system can allow a plurality of different options to be presented to a user of the entertainment system when an incoming phone call is detected. The user can choose an option, and the entertainment system can be configured to take appropriate action based on the option selected. Such a method allows the user of the entertainment system to make a real-time disposition of the incoming phone call, rather than relying solely on a predetermined set of configurations. In one embodiment, an apparatus and handset can be used in carrying out the method. In another embodiment, a handset for use with the entertainment system can be a remote control that includes telephone control features, or the handset can be used with VoIP connections.

### BACKGROUND

1. Field of the Disclosure

The present disclosure relates to methods of using entertainment systems, and more particularly to dispositioning phone calls using entertainment systems.

2. Description of the Related Art

Home entertainment systems are becoming a communications center within a home. Traditionally, handling telephone calls when watching television has been a manual process. More specifically, a user of a home entertainment system may receive notification on a display of the television, which is connected to a set-top box, that an incoming call has been detected. Information provided to the user may include just a notification that a call is detected or may include additional information, such as information available using caller identification. However, the home entertainment system is typically not capable of doing any further action regarding the call. For example, a user may need to manually turn down the volume level of the home entertainment system and manually go to the telephone to answer the call.

Another attempt to address telephone calls while using a home entertainment system has been to allow the user to enter data within a plurality of setup screens or other configurations specified by the user. These setup screens or configurations are defined before phone calls are received. Therefore, the user needs to anticipate many different possible scenarios when configuring the home entertainment system for phone calls. Such configuration does not allow for real-time decisions to be made by the user because the predetermined configurations determine how the telephone call will be handled. Inevitably, at least one scenario would not be anticipated by the user, and the telephone call may be dispositioned in a manner that the user does not desire.

### BRIEF DESCRIPTION OF THE DRAWINGS

FIG. 1 includes a block diagram of a home entertainment system.

FIG. 2 includes an illustration of a front side of a handset that can be used with the entertainment system of FIG. 1.

FIG. 3 includes an illustration of a back side of the handset of FIG. 2.

FIG. 4 includes a block diagram illustrating modules and their interaction between the handset and an apparatus of the entertainment system of FIG. 1.

FIG. 5 includes a flow diagram of a method of dispositioning phone calls using the system of FIG. 1.

Skilled artisans appreciate that elements in the figures are illustrated for simplicity and clarity and have not necessarily been drawn to scale.

### DETAILED DESCRIPTION

A method of using an entertainment system can allow a plurality of different options to be presented to a user of the entertainment system when an incoming phone call is detected. The user can choose one of the options, and the entertainment system can be configured to take appropriate action based on the option selected. Such a method allows the user of the entertainment system to make a real-time disposition of the incoming phone call, rather than relying solely on a predetermined set of configurations, where such predetermined set may not properly address a particular scenario or automatically change with different fact patterns. In one embodiment, a handset for use with the entertainment system can be a remote control modified to include telephone features, and in another embodiment, the handset can be used with VoIP connections.

In one aspect, a method of using an entertainment system can include detecting an incoming phone call received when the entertainment system is being used to play an audio stream, a video stream, or both, and transmitting a notification signal to a user of the entertainment system regarding the incoming phone call, wherein the notification signal includes a plurality of disposition options. The method can also include receiving a disposition selection signal from the user of the entertainment system, wherein the disposition selection signal corresponds to at least one of the plurality of disposition options and performing a first action corresponding to the disposition option associated with the disposition selection signal.

In one embodiment of the first aspect, the disposition selection signal corresponds to taking the incoming phone call, sending the incoming phone call to voice mail, ending the incoming phone call, blocking future incoming calls from the same telephone number or IP address, sending a recorded message in response to the incoming phone call, or any combination thereof. In another embodiment, taking the incoming phone call includes receiving an incoming audio stream of packets associated with the incoming phone call, transmitting the incoming audio stream of packets to a handset, receiving an outgoing audio stream of packets from the handset, and sending the outgoing audio stream of packets over a networked computer system.

In still another embodiment of the first aspect, the method further includes automatically performing a second action after detecting the incoming phone call. In a particular embodiment, the second action includes reducing a volume level for the audio stream being played by the entertainment system, pausing the audio stream, the video stream, or both when the incoming phone call is detected, sending a broadcast stream being received by the entertainment system to a recorder, changing a video signal that is provided by the entertainment system to a display unit, or any combination thereof. In another particular embodiment, the second action is performed in response to detecting the incoming phone call or in response to receiving the disposition selection signal.

In a second aspect, an apparatus can include a detection module to detect an incoming phone call received at an entertainment system that is playing an audio stream, a video stream, or both and a transmitting module configured to transmit a notification signal to a user of the apparatus regarding the incoming phone call, wherein the notification signal includes a plurality of disposition options. The apparatus can also include a receiving module configured to receive a disposition selection signal from the user of the apparatus, wherein the disposition selection signal corresponds to at least one of the disposition options, and an execution module to execute a first action corresponding to the disposition signal.

In one embodiment of the second aspect, the disposition selection signal corresponds to taking the incoming phone call, sending the incoming phone call to voice mail, ending the incoming phone call, blocking future incoming calls from the same telephone number or IP address, sending a recorded message in response to the incoming phone call, or any combination thereof. In a particular embodiment, the apparatus further includes an input/output (“I/O”) port configured to receive an incoming audio stream of packets corresponding to the incoming phone call. The transmitting module is further configured to send the incoming audio stream of packets to a handset, the receiving module is further configured to receive an outgoing audio stream of packets from the handset, and the I/O port is further configured to transmit the outgoing stream of audio packets to another device.

In a third aspect, a handset for use with an entertainment system can include a first side that includes a first phone call disposition control and a second side opposite the first side, wherein the second side includes a first set of controls configured to control an audio stream, a video stream, or both streams that are being processed by the entertainment system.

In another embodiment of the third aspect, the first side further includes a speaker that is configured to be used with a phone call. In a particular embodiment, the handset further includes a microphone that is configured to be used with a phone call. In still another embodiment, the first side further includes a second phone call disposition control that corresponds to a different disposition action compared to the first phone call disposition control. In yet another embodiment, the first side further includes an on/off control for a Voice over Internet Protocol phone.

In a further embodiment of the third aspect, the second side includes another set of controls selected from the group of a second set of controls for a QWERTY keyboard, a third set of controls configured for Internet navigation, and a fourth set of controls for a numeric keyboard. In a particular embodiment, the second side includes the second set of controls. In another particular embodiment, the second side includes the third set of controls. In still another particular embodiment, the second side includes the fourth set of controls. In a further particular embodiment, the second side includes the second set of controls, the third set of controls, and the fourth set of controls.

In a fourth aspect, a handset includes control buttons for use with an entertainment system. The handset can include a first set of controls configured for a phone call and at least two sets of controls selected from the group consisting of a second set of controls for a QWERTY keyboard, a third set of controls configured for Internet navigation, a fourth set of controls configured for controlling an audio program of the entertainment center, a video program of the entertainment center, or a combination thereof, and a fifth set of controls for a numeric keyboard. Different control buttons can be used for each of the first set of controls and the at least two sets of controls.

Before addressing details of embodiments described below, some terms are defined or clarified. As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or.

Additionally, for clarity purposes and to give a general sense of the scope of the embodiments described herein, the use of “a” or “an” are employed to describe one or more articles to which “a” or “an” refers. Therefore, the description should be read to include at least one whenever “a” or “an” is used, and the singular also includes the plural unless it is clear that the contrary is meant otherwise.

Unless stated otherwise, any combination of parts of a system may be bi-directionally or uni-directionally coupled to each other, even though a figure may illustrate only a single-headed arrow or a double-headed arrow. Arrows within the drawing are illustrated, as a matter of convenience, to show a principal information, data, or signal flow within the system or between the system and one or more component outside the system, one or more modules outside the system, another system, or any combination thereof in accordance with an embodiment. Coupling should be construed to include a direct electrical connection in one embodiment and alternatively, may include any one or more of an intervening switch, resistor, capacitor, inductor, router, firewall, network fabric or the like between any combination of one or more component, one or more devices, or one or more modules.

Unless otherwise defined, technical and scientific terms used herein have the same meaning as commonly understood by one of ordinary skill in the art. In addition, the materials, methods, and examples are illustrative only and not intended to be limiting.

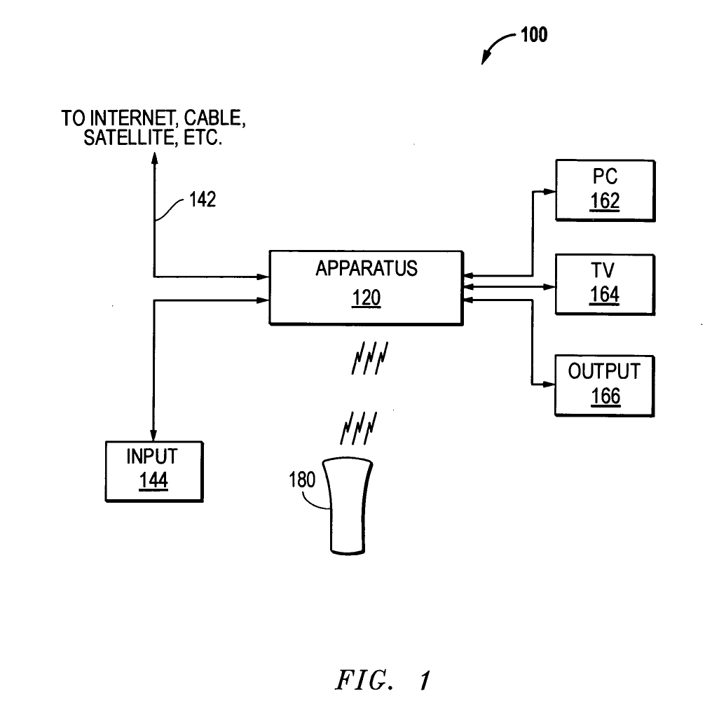

FIG. 1 includes a block diagram of an entertainment system 100, which in one particular embodiment, is a home entertainment system. The entertainment system 100 can be centrally controlled by an apparatus 120, which in one embodiment is a set-top box for a home entertainment center or a communications gateway, such as a residential gateway or a multimedia gateway. The apparatus 120 may receive input from any one or more sources including a subscriber line 142, which may be connected to an internet service provider, a cable service provider, a satellite dish, a telephone line, another conventional type of subscriber line (wireline or wireless), or any combination thereof. The apparatus 120 may also be connected to an input device 144. An example of the input device 144 can include a video cassette recorder (“VCR”), a digital video disk (“DVD”) player, an audio compact disc (“CD”) player, another conventional device that may be used in conjunction with an entertainment system, or any combination thereof.

The apparatus 120 may provide output to a personal computer (“PC”) 162, a television (“TV”) 164, or other output device 166. An example of the output device 166 can include a VCR, a DVD player, a CD burner, speakers, or another output device used with a home entertainment system, or any combination thereof. In one embodiment, each of the subscriber line 142, input device 144, personal computer 162, television 164, and output device 166 are bi-directionally coupled to the apparatus 120. In another embodiment, the subscriber line 142, input device 144, personal computer 162, television 164, output device 166, or any combination thereof may be directly connected to the apparatus 120, or may be uni-directionally coupled or connected to the apparatus 120 (allows signals to flow in only one direction).

The apparatus 120 can be controlled by a handset 180, which in one embodiment can be a remote control for the entertainment system 100. The handset 180 can communicate with the apparatus 120 using electronic signals, radio-frequency signals, optical signals, signals using other electromagnetic radiation, or any combination thereof. In one embodiment, the handset 180 does not need to contact or otherwise be tethered to the apparatus 120. In another embodiment (not illustrated), the handset 180 can be coupled to the apparatus 120 using one or more wires.

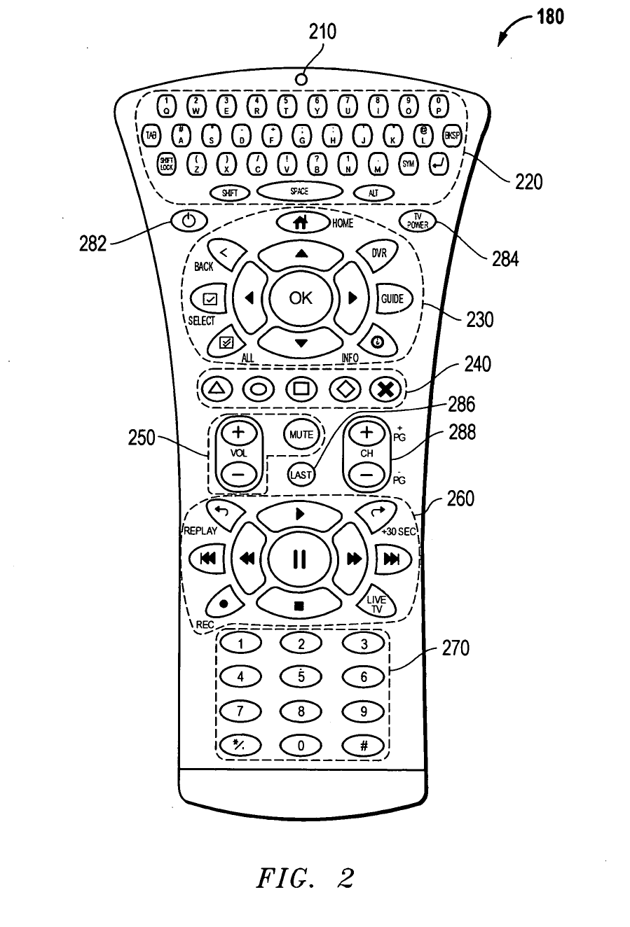

FIG. 2 includes an illustration of a front (principal) side of the handset 180 that includes a plurality of controls that by themselves or in conjunction with one another can be used to activate a function of the apparatus 120. The controls include buttons and keys in one embodiment. The handset 180 includes an activation indicator 210 that indicates when a control in the handset 180 has been activated. The handset 180 includes a plurality of different sets of controls, each within a different section of the handset 180. The sections can include a QWERTY keyboard section 220, Internet navigation section 230, a special features section 240, a volume control section 250, media control section 260, and a number pad section 270. The handset 180 can also include other sets of controls including an apparatus power control 282, a TV power control 284, a “last” button 286 that allows the user to go to the immediately prior channel that the user was viewing, and channel controls 288. The special features section 240 includes controls for play, summary, move, show/hide adult, content, delete, and the like. In other embodiments, more, fewer, or other controls may be part of the special features section. For example, the handset 180 may have one, two, three, four, five, or more sets of controls on the front side, wherein each set of controls is associated with one of the sections (e.g., QWERTY keyboard section 220) described herein. By having the different sets of controls, any one control button does not need to be used for three or more different functions.

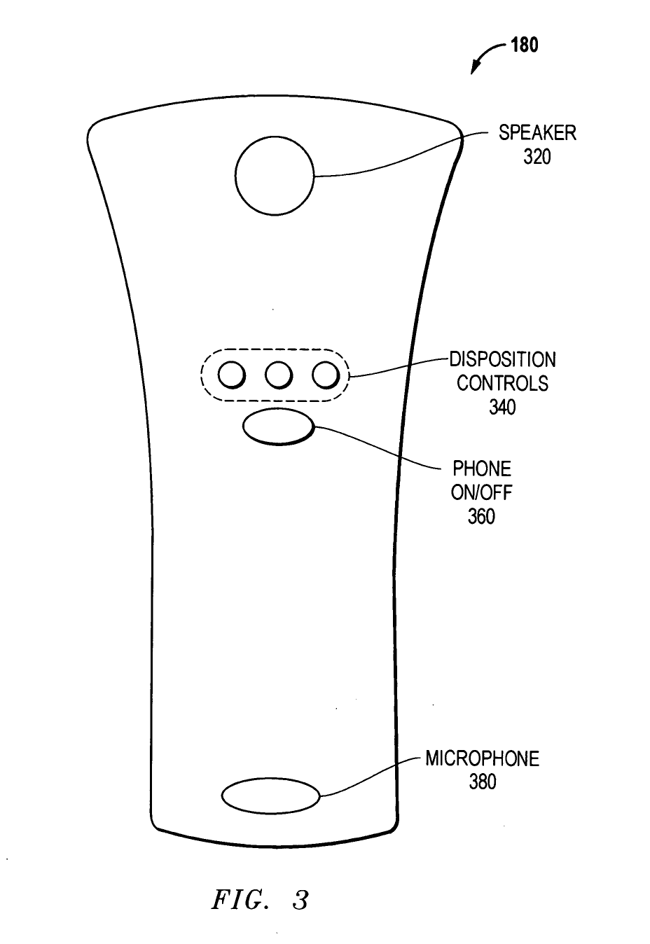

FIG. 3 includes an illustration of a back side of the handset 180. In one embodiment, the back side includes a speaker 320, disposition controls 340, a phone on/off control 360, and a microphone 380. In another embodiment, some or all of the features along the back side of the handset 180 may be located elsewhere within the handset 180. For example, the microphone 380 may be located along a side of the handset 180 between the front and back sides of the handset 180.

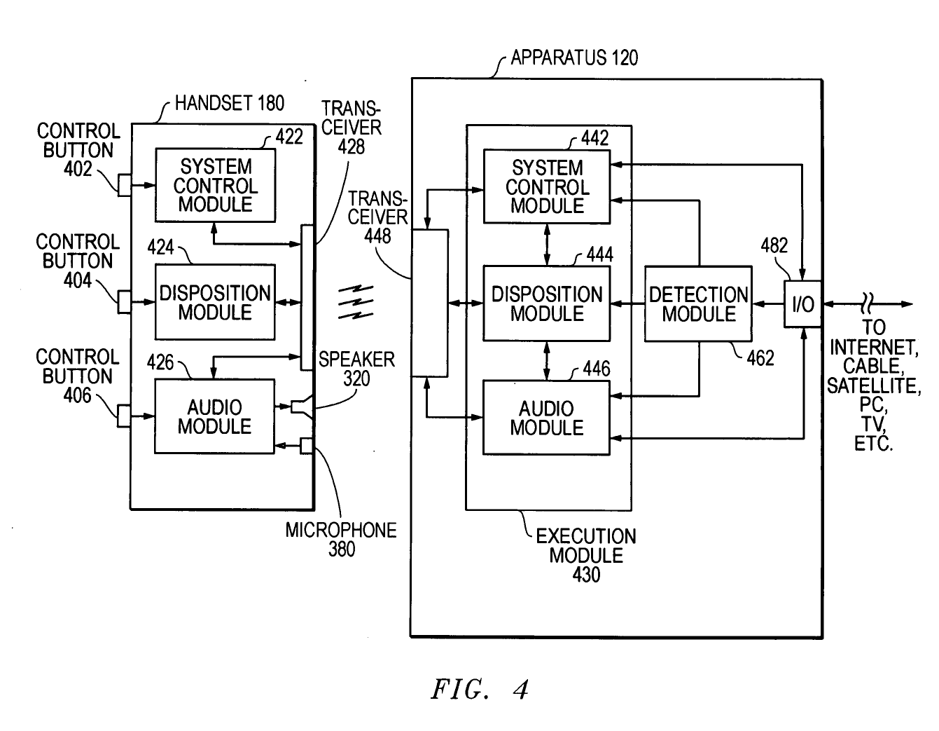

FIG. 4 includes a block diagram that illustrates interaction between the handset 180 and the apparatus 120. The handset 180 includes a system control module 422 that is coupled and configured to receive a signal from a control button 402. The control 402 can be nearly any control of the handset 180 as illustrated on the front side in FIG. 2. The handset 180 further includes a disposition module 424 that is coupled to and configured to receive a signal from a control button 404. The control button 404 may correspond to any one or more of the disposition controls 340 or the phone on/off control 360, as illustrated in FIG. 3. The handset still further includes an audio module 426 that is coupled to and configured to receive a signal from a control button 406. The control button 406 (not illustrated in FIG. 3) may correspond to a volume control for the speaker 320, the microphone 380, or a combination thereof. The audio module 426 is also coupled to the speaker 320 and the microphone 380. Audible signals can be received by the microphone 380 and converted to audio signals that are sent to the audio module 426. The audio module 426 can also receive audio signals from a transceiver 428 and can send audio signals to the speaker 320, which can convert the audio signals to sound that can be heard by humans. The system control module 422, the disposition module 424, and the audio module 426 are each bi-directionally coupled to the transceiver 428.

The apparatus 120 includes a transceiver 448 that is coupled to the transceiver 428 of the handset 180. The apparatus 120 also includes an execution module 430 that includes a system control module 442, a disposition module 444, and an audio module 446. The system control module 442, disposition module 444, and audio module 446 are each bi-directionally coupled to the transceiver 448. The apparatus 120 further includes a detection module 462 and an I/O port 482. The I/O port 482 is bi-directionally coupled to any one or more of the Internet, a coaxial cable, a satellite, the PC 162, the TV 164, or the like. Such devices connected to the I/O port 482 can include any or all of the input devices, output devices, or any combination thereof that are described or illustrated in FIG. 1. The apparatus 120 may include more than one I/O port 482.

The detection module 462 is coupled to and configured to receive a signal from the I/O port 482. The detection module 462 is configured to detect an incoming phone call received at the I/O port 482. In one embodiment, the entertainment system 100 may be playing an audio stream, a video stream, or both when the incoming phone call is detected by the detection module 462. The audio stream, the video stream, or the like may correspond to a broadcast program, a recorded program, a stream from an audio disc or a video disk, or any combination thereof. When the incoming call is detected, the detection module 462 is coupled to and can transmit a notification signal to the system control module 442, the disposition module 444, the audio module 446, or any combination thereof.

The disposition module 444 can be bi-directionally coupled to the system control module 442, the audio module 446, or both. In one embodiment, the disposition module 444 may send signals to the system control module 444, which can send disposition options to be displayed at a display of the entertainment system 100, such as the TV 164. The disposition module 444 can also be configured to transmit a signal to the audio module 446 to automatically reduce the volume level of an output device, such as the TV 164, speakers connected to the apparatus 120, one or more other audio output devices, or any combination thereof. In one embodiment, reducing the volume level includes muting sound from the audio portion of a stream using the entertainment system 100.

The user at the handset 180 can press the control button 404 that transmits a disposition select signal to the disposition module 424, which is transmitted from the handset 180 to the apparatus 120 via the transceivers 428 and 448. The disposition select signal can be sent to the execution module 430. The execution module may include hardware, firmware, software, or other appropriate logic to control the entertainment system 100 and to perform one or more functions in response to the disposition select signal received by the execution module 430. In one embodiment, the disposition select module 444 within the execution module 430 sends appropriate signals to the system control module 442, the audio module 446, or both. For example, if the disposition select signal is to take an incoming call, one or more signals may be sent to the system control module 442 to route an incoming broadcast signal to a recorder, and one or more other signals may be sent to the audio module 446 to mute or otherwise reduce the volume level from the entertainment system 100.

The apparatus 120 and handset 180 can each include a central processing unit (“CPU”), which is an example of a data processing system. Although not illustrated, other connections and memories may reside in or be coupled to the apparatus 120, the handset 180, or both. Although not illustrated, the apparatus 120, handset 180, or both can include additional memory including content addressable memory, static random access memory, cache, first-in-first-out (“FIFO”), other memory, or any combination thereof. The memories, potentially including a hard disk within the apparatus 120, can include media that can be read by the CPU within the apparatus 120. Each type of memory includes a data processing system readable medium suitable for data processing.

Portions of the methods described herein may be implemented in software code for carrying out the methods described. In one embodiment, the computer-executable instructions may be lines of assembly code or compiled C++, Java, or other language code. In another embodiment, the code may be contained on a data storage device, such as a hard disk, magnetic tape, floppy diskette, optical storage device, networked storage device(s), or other appropriate data processing system readable medium or storage device.

Functions preformed by any one or more of the modules described above may be combined with one or more other modules. For example, the system control module 422 and the audio module 426 may be combined into a single module, or the detection module 462 and the disposition module 444 may be combined into another single module. The module(s) may be part of or connected to the CPU within the apparatus 120 or handset 180. For example, the execution module 430 can be part of the CPU. Additionally, any one or more of the modules may be embodied in another portion of the entertainment system 100. In still another embodiment, any single module may be embedded within a plurality of integrated circuits, chip sets, circuit boards, or the like. Additionally, a software program or its software components with such code may be embodied in more than one data processing system readable medium in more than one computer or other item having a CPU.

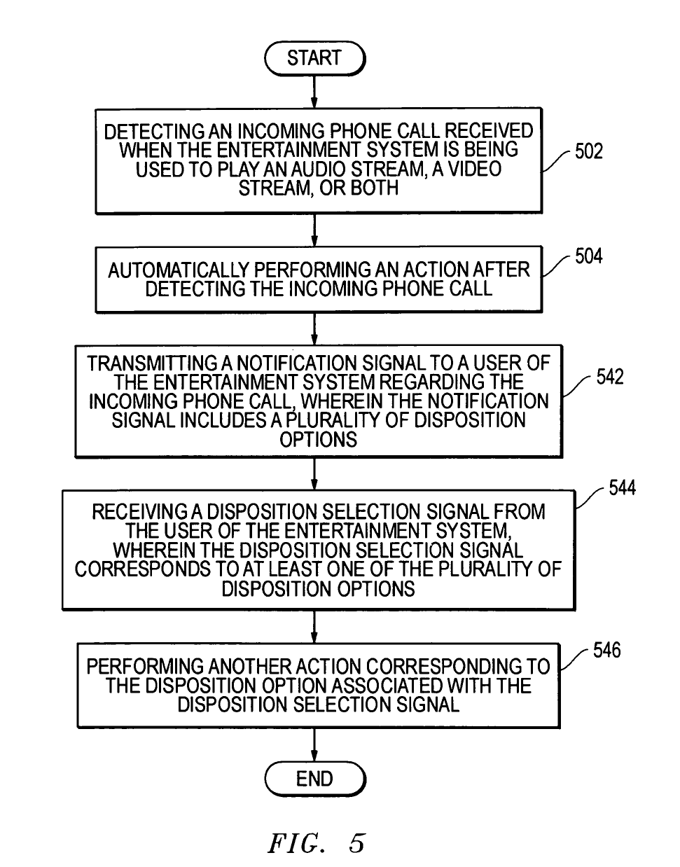

FIG. 5 includes a flow chart of an exemplary, non-limiting method of using the entertainment system 100. The method can include detecting an incoming phone call received when the entertainment system 100 is being used to play an audio stream, a video stream, or both (block 502).

The method can further include automatically performing an action after detecting the incoming phone call (block 504). The action can include reducing a volume level for the audio stream being played by the entertainment system 100, pausing the audio stream, the video stream, or both when the incoming phone call is detected, sending a broadcast stream being received by the entertainment system 100 to a recorder, changing a video signal that is provided by the entertainment system 100 to a display unit (e.g., TV 164), or any combination thereof. Note that muting the sound for one or more speakers within the entertainment system 100 is a specific example of reducing the volume level. The action can be performed in response to detecting the incoming phone call or in response to receiving a disposition selection signal, as described herein. Referring to FIG. 4, in one embodiment, when an incoming call is detected by the detection module 462, signals can be sent to the system control module 442, the audio module 446, or both to perform any one or more of the actions described herein.

The method can also include transmitting a notification signal to a user of the entertainment system 100 regarding the incoming phone call, wherein the notification signal includes a plurality of disposition options (block 542 in FIG. 5). Referring to FIG. 4, in one embodiment, the detection module 462 can send appropriate signals to the system control module 442, which in turn can display information regarding the caller and can display user selectable disposition options. The disposition options can correspond to actions such as taking the incoming phone call, sending the incoming phone call to voice mail, ending the incoming phone call (e.g., hanging up on the caller), blocking future incoming calls from the same telephone number or IP address, sending a recorded message in response to the incoming phone call, or any combination thereof.

In one exemplary, non-limiting embodiment, where the TV 164 is used as an active output device of the entertainment system 100, the following can be displayed:

John Smith is calling. 512-555-4589.

Send call to voice mail.

End call.

Give message.

Caller identification information can be displayed so that the user is aware of who is calling. Each of the three disposition options above can correspond to one of the disposition control buttons within the disposition controls 340.

The method can still further include receiving a disposition selection signal from the user of the entertainment system 100, wherein the disposition selection signal corresponds to at least one of the plurality of disposition options (block 544 in FIG. 5). The disposition select signal can correspond to taking the incoming phone call, sending the incoming phone call to voice mail, ending the incoming phone call (e.g., hanging up on the caller), sending a recorded message in response to the incoming phone call, or any combination thereof. Referring to FIG. 4, in one embodiment, the user presses the control button 404. The disposition module 424 within the handset 180 transmits one or more signals corresponding to control button 404 to the disposition module 442 within the apparatus 120 via the transceivers 428 and 448.

The method can yet further include performing another action corresponding to the disposition option associated with the disposition selection signal (block 546 in FIG. 5). Referring to 4, in one embodiment, the disposition module 444 can send one or more signals to the system control module 442, the audio module 446, or both to perform one or more actions that correspond to the disposition select signal received by the disposition module 444.

In one exemplary, non-limiting embodiment, when the disposition select signal corresponds to taking the incoming phone call, the other action can include receiving an incoming audio stream of packets associated with the incoming phone call. The audio stream of packets may be received by the I/O port 482 and may be routed to the transceiver 448 via the audio module 446 within the execution module 430 of the apparatus 120. The apparatus 120 can transmit the incoming audio stream of packets to the handset 180 via the transceiver 448. Within the handset 180, the audio stream associated with the incoming call is received by the audio module 426 via the transceiver 428. The audio module 426 can convert the audio stream to one or more audio signals that are transmitted to the speaker 320, to produce one or more audible signals that can be heard by the user of the handset 180. One or more audible signals from the user of the handset 180 can be received by the microphone 380, which converts the audible signal(s) to one or more audio signals that are transmitted to the audio module 426 of the handset 180. In one particular embodiment, the audio signal(s) can be converted to an outgoing stream of packets by the audio module 426. The handset 180 can transmit and the apparatus 120 can receive the outgoing audio stream of packets, via the transceivers 428 and 448. The audio module 446 within the apparatus 120 can send the outgoing audio stream of packets over a networked computer system (e.g., over the Internet) via the I/O port 428.

In one alternative embodiment, transceiver 428, transceiver 448, or both can be replaced by a separate transmitter and receiver. In still another embodiment, audio streams for phone calls may be routed through the apparatus 120 without passing through the audio module 446. For example, the disposition module 444 may be configured to route packets corresponding to the phone call to the I/O port 482.

In still other embodiments, the entertainment system 100 may allow the user to block future calls coming from the same telephone number or IP address.

The entertainment system 100 and methods described herein can allow for a user of the entertainment system 100 to select any one of a plurality of different disposition options using the handset 180 for the entertainment system 100. Each of the disposition options may be customized by a user to perform actions automatically by the entertainment system 100 when an incoming phone call is detected, when the user selects a disposition option, or both. By allowing a wider array of options, the user can make a real-time decision on how to handle the incoming call and is not solely dependent on predetermined actions selected during configuration setup.

In one embodiment, the handset 180 is more akin to a remote control for an entertainment center, rather than a cellular phone. The handset 180 has more control buttons than a conventional cellular phone. Therefore, the user does not have to memorize which button on the cellular phone corresponds to which function, nor does the user need to memorize the sequence of buttons (which buttons and order in pressing those buttons) that are needed to activate a function.

In still another embodiment, the handset 180 is not limited with its use to the apparatus 120. The handset 180 can act as a standalone VoIP phone and can be connected to a computer network via a wireline or wireless connection. Therefore, the user may be able to use the handset 180 to place phone calls using VoIP at any location where network access is available. Additionally, the handset 180 may be able to be used to program the apparatus 120 remotely to perform a function, such as to record a broadcast program. The apparatus 120 may receive signals from the handset 180 at the I/O port 482 of the apparatus via a computer network (e.g., the Internet) rather than the transceivers 428 and 448. Thus, the handset 180 can be more than one kilometer from the apparatus 120 and still be able to access the apparatus 120.

Note that not all of the activities described above in the general description or the examples are required, that a portion of a specific activity may not be required, and that one or more further activities may be performed in addition to those described. Still further, the order in which activities are listed are not necessarily the order in which they are performed. After reading this specification, skilled artisans will be capable of determining what activities can be used for their specific needs or desires.

Any one or more benefits, one or more other advantages, one or more solutions to one or more problems, or any combination thereof have been described above with regard to one or more particular embodiments. However, the benefit(s), advantage(s), solution(s) to problem(s), or any element(s) that may cause any benefit, advantage, or solution to occur or become more pronounced is not to be construed as a critical, required, or essential feature or element of any or all the claims.

The above-disclosed subject matter is to be considered illustrative, and not restrictive, and the appended claims are intended to cover all such modifications, enhancements, and other embodiments, which fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of using an entertainment system, the method comprising:
detecting an incoming phone call received when the entertainment system is being used to play an audio stream, a video stream, or both;
transmitting a notification signal to a user of the entertainment system regarding the incoming phone call, wherein the notification signal includes a plurality of disposition options;
receiving a disposition selection signal from the user of the entertainment system, wherein the disposition selection signal corresponds to at least one of the plurality of disposition options; and
performing a first action corresponding to the disposition option associated with the disposition selection signal.

2. The method of claim 1, wherein the disposition selection signal corresponds to:
taking the incoming phone call;
sending the incoming phone call to voice mail;
ending the incoming phone call;
blocking future incoming calls from a same telephone number or IP address;
sending a recorded message in response to the incoming phone call; or
any combination thereof.

3. The method of claim 2, wherein taking the incoming phone call comprises:
receiving an incoming audio stream of packets associated with the incoming phone call;
transmitting the incoming audio stream of packets to a handset;
receiving an outgoing audio stream of packets from the handset; and
sending the outgoing audio stream of packets over a networked computer system.

4. The method of claim 1, further comprising automatically performing a second action after detecting the incoming phone call.

5. The method of claim 4, wherein the second action includes:
reducing a volume level for the audio stream being played by the entertainment system;
pausing the audio stream, the video stream, or both that is being played using the entertainment system when the incoming phone call is detected;
sending a broadcast stream being received by the entertainment system to a recorder;
changing a video signal that is provided by the entertainment system to a display unit; or
any combination thereof.

6. The method of claim 4, wherein the second action is performed in response to detecting the incoming phone call or in response to receiving the disposition selection signal.

7. An apparatus comprising:
a detection module to detect an incoming phone call at an entertainment system that is playing an audio stream, a video stream, or both;
a transmitting module configured to transmit a notification signal to a user of the apparatus regarding the incoming phone call, wherein the notification signal includes a plurality of disposition options;
a receiving module configured to receive a disposition selection signal from the user of the apparatus, wherein the disposition selection signal corresponds to at least one of the plurality of disposition options; and
an execution module to execute a first action corresponding to the disposition selection signal.

8. The apparatus of claim 7, wherein the disposition selection signal corresponds to:
taking the incoming phone call;
sending the incoming phone call to voice mail;
ending the incoming phone call;
blocking future incoming calls from a same telephone number or IP address;
sending a recorded message in response to the incoming phone call; or
any combination thereof.

9. The apparatus of claim 8, further comprising an I/O) port configured to receive an incoming audio stream of packets corresponding to the incoming phone call, wherein:
the transmitting module is further configured to send the incoming audio stream of packets to a handset;
the receiving module is further configured to receive an outgoing audio stream of packets from the handset; and
the I/O port is further configured to transmit the outgoing stream of audio packets to another device.

10. The apparatus of claim 7, wherein the execution module is further configured to performing a second action after detecting the incoming phone call.

11. The apparatus of claim 10, wherein the second action includes:
reducing a volume level of the audio stream being played by the entertainment system;
pausing the audio stream, the video stream, or both that is being played using the entertainment system when the incoming phone call is detected;
sending a broadcast stream being received by the entertainment system to a recorder;
changing a video signal that is provided by the entertainment system to a display unit; or
any combination thereof.

12. The apparatus of claim 10, wherein the execution module is further configured to perform the second action in response to the detection module detecting the incoming phone call or in response to the receiving module receiving the disposition selection signal.

13. A handset for use with an entertainment system, the handset comprising:
a first side that comprises a first phone call disposition control; and
a second side opposite the first side, wherein the second side comprises a first set of controls configured to control an audio stream, a video stream, or both streams that are being processed by the entertainment system.

14. The handset of claim 13, wherein the first side further comprises a speaker that is configured to be used with a phone call.

15. The handset of claim 14, further comprising a microphone that is configured to be used with the phone call.

16. The handset of claim 13, wherein the first side further comprises a second phone call disposition control that corresponds to a different disposition action compared to the first phone call disposition control.

17. The handset of claim 13, wherein the first side further comprises an on/off control for a Voice over Internet Protocol phone.

18. The handset of claim 13, wherein the second side comprises another set of controls selected from the group consisting of:
a second set of controls for a QWERTY keyboard;
a third set of controls configured for Internet navigation; and
a fourth set of controls for a numeric keyboard.

19. The handset of claim 18, wherein the second side comprises the second set of controls.

20. The handset of claim 18, wherein the second side comprises the third set of controls.

21. The handset of claim 18, wherein the second side comprises the fourth set of controls.

22. The handset of claim 18, wherein the second side comprises the second set of controls, the third set of controls, and the fourth set of controls.

23. A handset including control buttons for use with an entertainment system, the handset comprising:
a first set of controls configured for a phone call; and
at least two sets of controls selected from the group consisting of:
a second set of controls for a QWERTY keyboard;
a third set of controls configured for Internet navigation;
a fourth set of controls configured for controlling an audio program of the entertainment system, a video program of the entertainment system, or a combination thereof; and
a fifth set of controls for a numeric keyboard,
wherein different control buttons are used for each of the first set of controls and the at least two sets of controls.

24. The handset of claim 23, wherein the at least two sets of controls comprise the second set of controls.

25. The handset of claim 23, wherein the at least two sets of controls comprise the fourth set of controls.

26. The handset of claim 23, wherein the at least two sets of controls comprise the fifth set of controls.

27. The handset of claim 23, wherein the at least two sets of controls comprise the second set of controls, the third set of controls, the fourth set of controls, and the fifth set of controls.

28. The handset of claim 23, further comprising a first side and a second side opposite the first side, wherein:
the first side has a first set of control buttons corresponding to the first set of controls; and
the second side has control buttons corresponding to the at least two sets of controls.

29. The handset of claim 28, wherein the first side further comprises a speaker that is configured to be used with a phone call and a microphone that is configured to be used with the phone call.
